(19) United States
(12) Patent Application Publication
(10) Pub. No.: US 2015/0231976 A1
(43) Pub. Date: Aug. 20, 2015

(54) ELECTRIC VEHICLE POWER RELAY ASSEMBLY

(71) Applicant: Hyundai Motor Company, Seoul (KR)

(72) Inventors: Young Chan Byun, Seoul (KR); Sang-Hwan Kim, Suwon (KR); Dongjin Nam, Hwaseong (KR); Yong Hyun Kim, Seoul (KR); Tae Jin Kim, Incheon (KR)

(21) Appl. No.: 14/329,120

(22) Filed: Jul. 11, 2014

(30) Foreign Application Priority Data
Feb. 17, 2014 (KR) 10-2014-0017811

(51) Int. Cl. B60L 11/18; H02H 9/00; B60L 3/00

(52) U.S. Cl. CPC B60L 11/185; B60L 3/0084; B60L 11/1818; H02H 9/001

(57) ABSTRACT

The electric vehicle may comprise a high voltage battery, a power relay assembly (PRA) connected to the high voltage battery and an inverter capacitor. The PRA may comprise a first main relay connected to an anode of the high voltage battery, a second main relay connected to a cathode of the high voltage battery, and a precharge relay and a precharge resistor coupled in parallel to at least one of the first and the second main relay.

### CROSS-REFERENCE TO RELATED APPLICATION

The present application claims priority of Korean Patent Application Number 10-2014-0017811 filed on Feb. 17, 2014, the entire contents of which application are incorporated herein for all purposes by this reference.

### BACKGROUND OF INVENTION

1. Field of Invention

The present invention relates to an electric vehicle power relay assembly.

2. Description of Related Art

Electric vehicles employ a plethora of high voltage components in order to quickly charge and discharge electricity throughout the vehicle. During high-speed charging, a phenomenon can occur in which a relay is melted and becomes fused together due to a capacitor component of high-speed battery charger being charged repeatedly.

When a high voltage relay becomes fused, a locking device of the high-speed battery charger cannot be released thereby increasing the risk that a user will receive a shock. As such, when this happens the vehicle must be brought to a repair facility at which a high voltage relay is often replaced for the users' safety. This component, however, is not easy to replace since the battery needs to be unloaded from the vehicle.

Currently, there are two major standards used in high-speed charging standards. The two major standards are SGS run by Korea Smart Grid Association and CHAdeMO run by the Japanese association standard. These standards limit rush current from being supplied.

The above information disclosed in this Background section is only for enhancement of understanding of the background of the invention and therefore it may contain information that does not form the prior art that is already known in this country to a person of ordinary skill in the art.

### SUMMARY OF INVENTION

Various aspects of the present invention are directed to providing an electric vehicle preventing a high voltage relay from becoming fused. In various aspects of the present invention, the electric vehicle may include a high voltage battery, a power relay assembly (PRA) connected to the high voltage battery and an inverter capacitor.

In particular, the PRA may include a first main relay connected to an anode of the high voltage battery, a second main relay connected to a cathode of the high voltage battery, and a precharge relay and a precharge resistor coupled in parallel to the main relay. In this case, the high voltage relay can be prevented from becoming fused by limiting an inrush current to the according the exemplary embodiment of the present invention.

### BRIEF DESCRIPTION OF THE DRAWINGS

FIG. 1 is a drawing showing a power unit of an exemplary electric vehicle according to the present invention.

FIG. 2 is a drawing showing a power unit of another exemplary electric vehicle according to the present invention.

### DETAILED DESCRIPTION

In the following detailed description, only certain exemplary embodiments of the present invention have been shown and described, simply by way of illustration.

As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element.

In addition, unless explicitly described to the contrary, the word “comprise” and variations such as “comprises” or “comprising”, will be understood to imply the inclusion of stated elements but not the exclusion of any other elements.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles, fuel cell vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

In an exemplary embodiment, a relay sequence is changed for prevention of a rush current by using a precharge relay equipped in an electric vehicle.

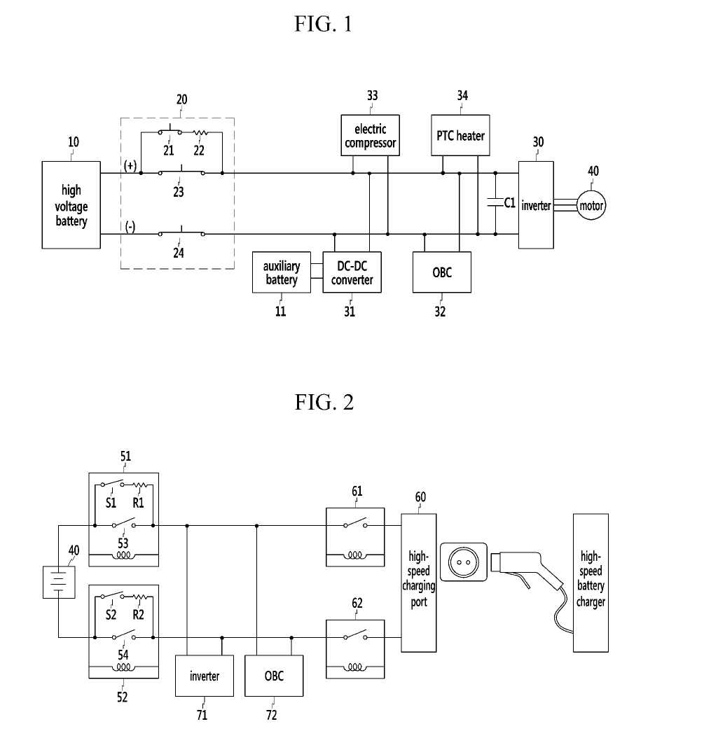

Hereinafter, referring to FIG. 1 and FIG. 2 an exemplary embodiment of the present invention will be explained. FIG. 1 is a drawing showing a power unit of an exemplary electric vehicle according to the present invention. As shown in FIG. 1, a high voltage battery 10 (i.e., a battery capable of providing enough power to drive an electric vehicle) is connected to a DC-DC converter 31, an on-board charger (OBC) 32, an electric compressor 33, and a positive temperature coefficient (PTC) heater 34 through a power relay assembly (PRA) 20.

More specifically, the high voltage battery 10 is used as a power supply for the DC-DC converter 31, the OBC 32, the electric compressor 33 and the PTC heater 34. An inverter 30 converts power of the high voltage battery 10 to 3-phase power and drives a motor 40. Between the inverter 30 and the PRA 20 exists an inverter capacitor C1 in order to provide a continuously smooth power supply. The DC-DC converter 31 may also be connected to an auxiliary battery 11.

In particular, according to the exemplary embodiment of the present invention PRA 20 comprises a main relay 23 connected to an anode of the high voltage battery 10, a main relay 24 connected to a cathode of the high voltage battery 10, and a precharge relay 21 and a precharge resistor 22 coupled in parallel with the main relay 23 to the anode of the high voltage battery 10.

One end of the precharge relay 21 may be connected to the anode of the high voltage battery 10 and one end of the main relay 23, an opposite end of the precharge relay 21, is connected to an opposite end of the main relay 23 through the precharge resistor 22. The precharge relay 21 may be coupled in parallel to an anode of the main relay 23 of the PRA 20 to correlate to the inverter capacitor C1.

When the high voltage battery 10 is connected to the inverter capacitor C1 through the precharge resistor 22 by being connected to the precharge relay 21, a current is delayed under a time constant RC according to resistance of the precharge resistor 22 and capacitance of the inverter capacitor C1. As a result, rush current is prevented and the main relay 23 connected to the high voltage battery 10 is protected.

The main relay 24 may be turned on after a rush current is prevented by the precharge relay 21 being connected to the high voltage battery 10 and the delay of a current in accordance with a time constant RC. Then, an electric circuit is formed by the precharge relay 21 and the main relay 24. Next the main relay 23 is turned on and the precharge relay 21 is opened and consequently off. As a result, an electric driving circuit is formed through the main relay 23 and the main relay 24. Thus, during high-speed charging, the phenomenon of a high voltage relay becoming fused is solved by preventing of a rush current through the use of a precharge relay.

FIG. 2 is a drawing showing a power unit of another exemplary electric vehicle according to the present invention. As shown in FIG. 2, between a high-speed charging port 60 and a high voltage battery 40 are a main relay 51 and 52 and a high-speed charging relay 61 and 62 connected. The high voltage battery 40 is a power supply of an inverter 71 and an OBC 72.

The main relay 51 is connected to an anode of the high voltage battery 40 and the high-speed charging relay 61 is connected between the main relay 51 and the high-speed charging port 60. The main relay 52 is connected to a cathode of the high voltage battery 40 and the high-speed charging relay 62 is connected between the main relay 52 and the high-speed charging port 60.

The main relay 51 and the main relay 52 comprise a precharge relay S1 and a precharge resistor R1 and a precharge relay S2 and a precharge resistor R2 respectively. The precharge relay S1 and the precharge resistor R1 are coupled in parallel to a relay 53 and the precharge relay S2 and the precharge resistor R2 are coupled in parallel to a relay 54.

A rush current can be prevented by changing the operating order of the main relay 51 and 52 and the high-speed charging relay 61 and 62, even if there is a capacitor component in a high-speed battery charger.

For example, a high-speed charging relay 61 and 62 and a precharge relay S1 and S2 may be first turned on. Then, a current is delayed under a time constant RC in accordance with a precharge resistor R1 and R2 and a capacitor of a high-speed battery charger. Next a relay 53 and 54 are turned on and the precharge relay Si and S2 are opened. Then, even if there is a capacitor component in the high-speed battery charger, a rush current and a fusing phenomenon of high voltage relay can be prevented by the delay of a current.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An electric vehicle comprising a high voltage battery, a power relay assembly (PRA) connected to the high voltage battery, and an inverter capacitor,
wherein the PRA comprises a first main relay connected to an anode of the high voltage battery, a second main relay connected to a cathode of the high voltage battery, and a precharge relay and a precharge resistor coupled in parallel to at least one of the first and the second main relay.

2. The electric vehicle of claim 1, wherein one end of the precharge relay is connected to the anode and one end of the first main relay and an opposite end of the precharge relay is connected to an opposite end of the first main relay through the precharge resistor.

3. The electric vehicle of claim 1, wherein the precharge relay is connected to the high voltage battery such that the high voltage battery is connected to the inverter capacitor through the precharge resistor.

4. The electric vehicle of claim 3, wherein the PRA is configured to delay current under a time constant RC in accordance with the precharge resistor and the inverter capacitor.

5. The electric vehicle of claim 3, wherein the second main relay is configured to be turned on after the precharge relay is turned on.

6. The electric vehicle of claim 5, wherein the first main relay is configured to be turned on and the precharge relay becomes off after the second main relay is turned on.

7. The electric vehicle of claim 1, wherein the high voltage battery is connected to at least one of a DC-DC converter, an on-board charger (OBC), an electric compressor, and a positive temperature coefficient (PTC) heater and is used as a main power supply for the electric vehicle.

8. The electric vehicle of claim 1, wherein the electric vehicle further includes an inverter supplying 3-phase inverter power to a motor through the inverter capacitor.

9. An electric vehicle connected to a high-speed battery charger through a charging port, comprising:
a high voltage battery;
a first main relay, a second main relay, a first charging relay and a second charging relay connected between the high voltage battery and the charging port,
wherein the first main relay includes a first relay, a first precharge relay and a first precharge resistor and the second main relay includes a second relay, a second precharge relay and a second precharge resistor, and
wherein the first precharge relay and the second precharge relay are configured to be turned on when the first and the second high-speed charging relay are turned on.

10. The electric vehicle of claim 9, wherein a current is delayed under a time constant RC in accordance with the first precharge resistor, the second precharge resistor, and a capacitor of the charging port.

11. The electric vehicle of claim 9, wherein the first relay and the second relay are turned on after the first and the second precharge relay are turned on and when the first and the second relay are turned on the first and the second precharge relay are opened.

12. A power relay assembly (PRA) connected to a battery supplying power to drive an electric vehicle, the PRA comprising:
a first main relay connected to an anode of the battery;
a second main relay connected to a cathode of the battery; and
a precharge relay and a precharge resistor coupled in parallel to at least one of the first and the second main relay.

13. The PRA of claim 1, wherein one end of the precharge relay is connected to the anode and one end of the first main relay and an opposite end of the precharge relay is connected to an opposite end of the first main relay through the precharge resistor.

14. The PRA of claim 1, wherein the precharge relay is connected to the high voltage battery such that the high voltage battery is connected to an inverter capacitor through the precharge resistor.

15. The PRA of claim 14, wherein the PRA is configured to delay current under a time constant RC in accordance with the precharge resistor and the inverter capacitor.

16. The PRA of claim 14, wherein the second main relay is configured to be turned on after the precharge relay is turned on.

17. The PRA of claim 16, wherein the first main relay is configured to be turned on and the precharge relay becomes off after the second main relay is turned on.

18. The PRA of claim 12, wherein the battery is connected to at least one of a DC-DC converter, an on-board charger(OBC), an electric compressor, and a positive temperature coefficient (PTC) heater and is used as a main power supply for the electric vehicle.
